(19) United States
(12) Patent Application Publication
(10) Pub. No.: US 2009/0303871 A1
(43) Pub. Date: Dec. 10, 2009

(54) METHOD AND APPARATUS FOR PACKET AGGREGATION ACCORDING TO TRAFFIC CHARACTERISTICS

(75) Inventors: Yong Sun KIM, Suwon-si (KR); Jin Kyeong KIM, Daejeon (KR); Seung Eun HONG, Daejeon (KR); Woo Yong LEE, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS TELECOMMUNICATIONS RESEARCH INSTITUTE, Daejeon (KR)

(21) Appl. No.: 12/482,023

(22) Filed: Jun. 10, 2009

(30) Foreign Application Priority Data
Jun. 10, 2008 (KR) 10-2008-0054356
Nov. 6, 2008 (KR) 10-2008-0109873

(51) Int. Cl. H04L 1/00

(52) U.S. Cl. 370/216

(57) ABSTRACT

A method and apparatus for packet aggregation is provided. The apparatus for packet aggregation may include an upper layer management unit to generate a plurality of Media Access Control (MAC) Service Data Units (MSDUs) and traffic characteristic information of each of the plurality of MSDUs; a MAC layer management unit to determine a sequence number of each of the plurality of MSDUs based on the traffic characteristic information of each of the plurality of MSDUs, and to generate an aggregated MAC Protocol Data Unit (MPDU) based on the sequence number of each of the plurality of MSDUs; and a physical (PHY) layer management unit to transmit the aggregated MPDU to a destination.

### CROSS-REFERENCE TO RELATED APPLICATIONS

This application claims the benefit of Korean Patent Application Nos. 10-2008-0054356, filed on Jun. 10, 2008 and 10-2008-0109873, filed on Nov. 6, 2008, in the Korean Intellectual Property Office, the disclosures of which are incorporated herein by reference.

### TECHNICAL FIELD

The present invention relates to a method and apparatus for packet aggregation according to traffic characteristics, and more particularly, to a method and apparatus for packet aggregation which joins a plurality of Media Access Control (MAC) Service Data Units (MSDUs) into a single MAC Protocol Data Unit (MPDU) for transmission in a super high-speed wireless communication system.

### BACKGROUND ART

A super high-speed wireless communication system may use packet aggregation to improve a data rate by reducing an overhead which unnecessarily occurs. Packet aggregation in a super high-speed wireless communication system joins a plurality of Media Access Control (MAC) Service Data Units (MSDUs) into a single long packet for transmission.

In a packet aggregation in a conventional art, when an error occurs while receiving an aggregated packet, an entire MAC Protocol Data Unit (MPDU) is to be retransmitted.

MSDUs where an error occurred from among the aggregated packet may be transmitted by filling to a head portion of a subsequent aggregated MPDU.

In this instance, a lower layer of receiving end is required to forward a received MSDU to an upper layer in an order of increased sequence number of the received MSDU. Accordingly, successful MSDUs, located behind an MSDU where an error occurred, are required to be maintained in a buffer until the MSDU where the error occurred is re-received or a receiving timer expires.

Also, a transmission end may aggregate MSDUs, which are to be newly transmitted since the MSDU where the error occurred is included, into a subsequent aggregated MPDU for transmission. Accordingly, a time delay may occur.

There may be bits which report whether retransmission is required for each MSDU included in an MPDU when an error occurs.

In this instance, when an error occurs in a packet requiring retransmission, in the receiving end, MSDUs that exist in the same MPDU but do not require retransmission, may be maintained in the buffer and may not be transmitted to the upper layer. Also, the transmission end may retransmit MSDUs requiring retransmission using a predetermined retransmission mechanism. In this instance, the retransmission may be useless in the case of a delay-sensitive traffic.

### DISCLOSURE OF INVENTION

### Technical Goals

An aspect of the present invention provides a method and apparatus for packet aggregation according to traffic characteristics where a transmission end may determine whether retransmission is required upon errors for each Media Access Control (MAC) Service Data Unit (MSDU) in an aggregated MAC Protocol Data Unit (MPDU) based on the traffic characteristic and traffic type without a separate receiving/transmission frame and process.

An aspect of the present invention also provides a method and apparatus for packet aggregation which, when an error occurs, may first forward MSDUs, that do not require retransmission and are placed in a head portion of a corresponding aggregated MPDU by placing MSDUs that require retransmission in a rear portion of the aggregated MPDU, and thereby may efficiently use a receiving buffer and reduce a time delay.

An aspect of the present invention also provides a method and apparatus for packet aggregation where, when retransmission is required, a transmission end may directly transmit only MSDUs that require retransmission without waiting until a subsequent aggregated MSDU is made.

### Technical Solutions

According to an aspect of the present invention, there is provided an apparatus for packet aggregation, the apparatus including: an upper layer management unit to generate a plurality of Media Access Control (MAC) Service Data Units (MSDUs) and traffic characteristic information of each of the plurality of MSDUs; a MAC layer management unit to determine a sequence number of each of the plurality of MSDUs based on the traffic characteristic information of each of the plurality of MSDUs, and to generate an aggregated MAC Protocol Data Unit (MPDU) based on the sequence number of each of the plurality of MSDUs; and a physical (PHY) layer management unit to transmit the aggregated MPDU to a destination.

According to another aspect of the present invention, there is provided an apparatus for packet aggregation, the apparatus including: a PHY layer management unit to receive an aggregated MPDU including a plurality of MSDUs and an RROE field indicating whether retransmission is required for each of the plurality of MSDUs when an error occurs; and a MAC layer management unit to forward the plurality of MSDUs to an upper layer based on a sequence number of each of the plurality of MSDUs, and when the error occurs in at least one MSDU of the plurality of MSDUs, the MAC layer management unit determines whether to forward an error-free MSDU to the upper layer based on an RROE field of the MSDU where the error occurred.

### Advantageous Effects

According to an embodiment of the present invention, in a method and apparatus for packet aggregation according to traffic characteristics, a transmission end may determine whether retransmission is required upon errors for each Media Access Control (MAC) Service Data Unit (MSDU) in an aggregated MAC Protocol Data Unit (MPDU) based on the traffic characteristic and traffic type without a separate receiving/transmission frame and process.

According to an embodiment of the present invention, in a method and apparatus for packet aggregation, when an aggregated packet requiring a high-speed transmission, such as an aggregated packet where a video and an audio are combined, is transmitted, a receiving end may forward the video to an upper layer without delay even when an error occurs, and may retransmit the audio within a delay request time, calculated by the receiving end or a transmission end, when an error occurs.

### BRIEF DESCRIPTION OF DRAWINGS

FIG. 1 is a block diagram illustrating a configuration of an apparatus for packet aggregation according to an embodiment of the present invention;

FIG. 2 is a block diagram illustrating a configuration of an apparatus for packet aggregation according to another embodiment of the present invention;

FIG. 3 is a diagram illustrating an example of a frame format of an aggregated Media Access Control (MAC) Protocol Data Unit (MPDU) according to an embodiment of the present invention;

FIG. 4 is a diagram illustrating an example of a format of a MAC payload field of FIG. 3;

FIG. 5 is a flowchart illustrating a method of packet aggregation according to an embodiment of the present invention;

FIG. 6 is a flowchart illustrating a method of packet aggregation according to another embodiment of the present invention;

FIG. 7 is a diagram illustrating an example of a packet aggregation without a Retransmission Required On Errors (RROE) field in a conventional art;

FIG. 8 is a diagram illustrating an example when an RROE field is set as 0 according to an embodiment of the present invention;

FIG. 9 is a diagram illustrating an example when an RROE field is set as 1 according to an embodiment of the present invention; and

FIG. 10 is a diagram illustrating another example when an RROE field is set as 1 according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

In a packet aggregation in a super high-speed wireless transmission system according to an embodiment of the present invention, a transmission end is required to have information about a buffer state of a receiving end, and is required to determine a number of Media Access Control (MAC) Service Data Units (MSDUs) to be aggregated and a length of each of the MSDUs based on a state of a wireless channel.

The transmission end may receive the buffer state of the receiving end from the receiving end while performing a process for the packet aggregation. A length and a size of an aggregated MAC Protocol Data Unit (MPDU) may be adjusted based on a buffer capacity that may be processed by the receiving end, and thus an error of reception of an unnecessary packet may be prevented and retransmission may be reduced.

The receiving end may forward a current buffer state, that is, a length of an available receiving buffer and a maximum number of processible MSDUs, to the transmission end every time the aggregated MPDU is received. The forwarded information may be generally included in an acknowledgement (ACK) frame such as a Block ACK, a Delayed ACK, and the like.

Also, the transmission end receives receiving channel state information from the receiving end, or when the retransmission mechanism is not provided, the transmission end may obtain the receiving channel state information of the receiving end using a receiving channel state of the transmission end. Accordingly, the packet aggregation may be performed by limiting the length of the aggregated MPDU and the number of MSDUs.

Also, the transmission end may apply different Modulation and Coding Schemes (MCSs) depending on a packet type of the aggregated MSDUs. Accordingly, an MSDU of an important packet type may use a scheme that may cause fewer errors in a channel having a same transmission error rate. That is, a video packet including control information, an audio, and upper bits may be primarily protected, and a packet which is not sensitive to an error or relatively less important such as video data including lower bits and general high-speed communication data may be least protected. Accordingly, a data rate may be appropriately maintained, critical information may be prevented from being lost, and retransmission may be reduced.

In a High Definition Media Interface (HDMI) mainly applied in a broadband wireless communication, video and audio information may be generated in a high speed and forwarded to a lower layer. In this case, the audio and video may be combined and aggregated into a single aggregated MPDU. Here, both the audio and video may have delay-sensitive traffic characteristics. However, when an error occurs, the video may not require retransmission, while the audio may require retransmission. That is, a video packet including lower bits from among video packets where an Unequal Error Protection (UEP) is applied or a video packet where the UEP is not applied does not require retransmission.

In the HDMI, a valid delay time to configure a scene may vary depending on a resolution in the receiving end. However, the valid delay time may be approximately 10 m/sec, that is, the valid delay time may be short, and thus the retransmission is required to be performed quickly.

Accordingly, when a packet which combines the audio and the video and requires high speed transmission is transmitted, a method where the receiving end may forward the video to the upper layer without any delay even when an error occurs, and may retransmit the audio upon errors within a delay request time calculated by the transmission end or the receiving end is required.

Hereinafter, a method and apparatus for packet aggregation is described. Also, a transmission end is referred to as a transmission apparatus or a source, and a receiving end is referred to as a receiving apparatus. In this instance, the apparatus for packet aggregation may include a transmission apparatus for packet aggregation and a receiving apparatus for packet aggregation.

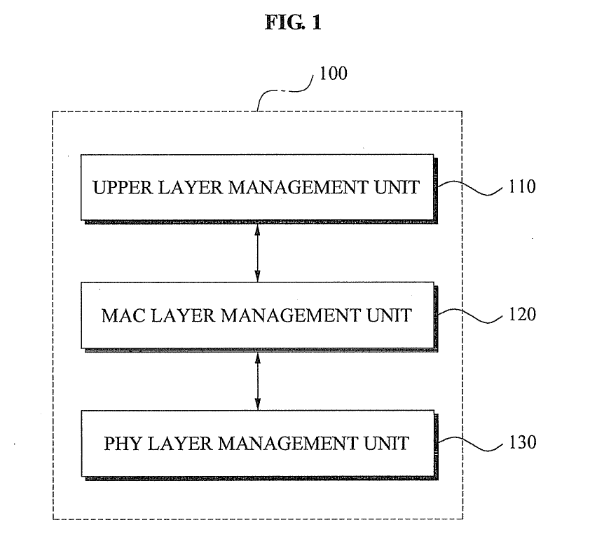

FIG. 1 is a block diagram illustrating a configuration of an apparatus for packet aggregation 100 according to an embodiment of the present invention.

Referring to FIG. 1, the apparatus for packet aggregation 100 may be a transmission apparatus performing packet aggregation, and include an upper layer management unit 110, a MAC layer management unit 120, and a physical (PHY) layer management unit 130.

The upper layer management unit 110 may generate a plurality of MSDUs and traffic characteristic information of each of the plurality of MSDUs, and forward the traffic characteristic information to the MAC layer management unit 120.

The MAC layer management unit 120 may determine a sequence number of each of the plurality of MSDUs based on the traffic characteristic information of each of the plurality of MSDUs, and generate an aggregated MPDU based on the sequence number of each of the plurality of MSDUs.

In this instance, the aggregated MPDU may include a Retransmission Required On Errors (RROE) field indicating whether retransmission is required for each of the plurality of MSDUs when an error occurs. A frame format of the aggregated MPDU and the RROE field are described below in detail.

In this instance, the MAC layer management unit 120 may determine a sequence number of an MSDU, that requires retransmission upon errors, to be greater than a sequence number of an MSDU that does not require retransmission upon errors from among the plurality of MSDUs.

That is, the MAC layer management unit 120 may determine the sequence number of each of the plurality of MSDUs to enable the MSDU requiring retransmission upon errors to be located in a tail portion of the aggregated MPDU.

When an acknowledgement (ACK) frame corresponding to the aggregated MPDU is received, the MAC layer management unit 120 may confirm which MSDUs, that require retransmission upon errors, an error occurs in from among the plurality of MSDUs, using the ACK frame. Also, the MAC layer management unit 120 may determine a retransmission scheme of an MSDU where the error occurred from among the MSDUs requiring retransmission upon errors, based on a delay request of the MSDU where the error occurred.

The retransmission scheme may be any one of a retransmission scheme of including the MSDU where the error occurred in a subsequent aggregated MPDU for retransmission, a retransmission scheme of configuring a plurality of MSDUs where errors occurred as the aggregated MPDU for retransmission, and a retransmission scheme of configuring a single MSDU where the error occurred as an MPDU for retransmission.

Here, the MPDU may be different from the aggregated MPDU, and include only single MSDU.

The retransmission scheme may be selected according to a predetermined condition. Also, a variety of standards may be applied to the retransmission scheme. For example, when the delay requirement of the MSDU where the error occurred from among the MSDUs requiring retransmission is high, the retransmission scheme of including the MSDU where the error occurred in the subsequent aggregated MPDU for retransmission or the retransmission scheme of configuring the single MSDU where the error occurred as the MPDU for retransmission may be used. When the delay requirement of the MSDU where the error occurred from among the MSDUs requiring retransmission is low, an aggregated retransmission MPDU may be generated by aggregating a predetermined number of MSDUs requiring retransmission, and thereby may retransmit the aggregated retransmission MPDU to a destination.

The MAC layer management unit 120 may determine whether retransmission is required when the error re-occurs in the MSDU where the error occurred, based on a predetermined maximum number of retransmissions, and the delay request of the MSDU where the error occurred from among the MSDUs requiring retransmission upon errors.

In this instance, the delay requirement of the MSDU where the error occurred may be high or low depending on how delay-sensitive the MSDU where the error occurred is. The predetermined maximum number of retransmissions may indicate a number of times that a corresponding MSDU is attempted to be retransmitted. Accordingly, when the predetermined maximum number of retransmissions of the MSDU where the error occurred is N (N=1, 2, . . . , n), and retransmission is currently performed N number of times, an RROE field of the MSDU where the error occurred may be set as ‘0’. In this instance, when the RROE field is ‘1’, it may be assumed that retransmission is required when the error occurs. Also, when the RROE field is ‘0’, it may be assumed that retransmission is not required when the error occurs.

The PHY layer management unit 130 may transmit the aggregated MPDU to a destination. Also, the PHY layer management unit 130 may receive and forward a maximum number of processible MSDUs, a capacity of a receiving buffer, and the ACK frame of a receiving apparatus, corresponding to the destination, to the upper layer.

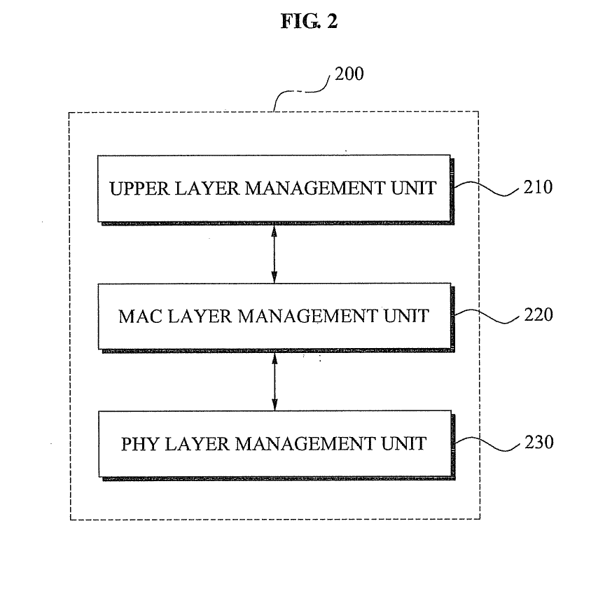

FIG. 2 is a block diagram illustrating a configuration of an apparatus for packet aggregation 200 according to another embodiment of the present invention.

Referring to FIG. 2, the apparatus for packet aggregation 200 may be a receiving apparatus performing packet aggregation, and include an upper layer management unit 210, a MAC layer management unit 220, and a PHY layer management unit 230.

The upper layer management unit 210 may receive an MSDU from the MAC layer management unit 220 and perform operations required in an upper layer.

The PHY layer management unit 230 may receive an aggregated MPDU from a transmission apparatus corresponding to a source, and forward the aggregated MPDU to the MAC layer management unit 220.

Also, the PHY layer management unit 230 may transmit a capacity of a receiving buffer and an ACK frame of the aggregated MPDU to the transmission apparatus, or receive a request for the capacity of the receiving buffer from the transmission apparatus.

In this instance, the aggregated MPDU, received in the PHY layer management unit 230, may include an RROE field indicating whether retransmission is required for each of a plurality of MSDUs when an error occurs.

The MAC layer management unit 220 may forward the plurality of MSDUs to an upper layer in an order of a sequence number of each of the plurality of MSDUs. When the error occurs in at least one MSDU of the plurality of MSDUs, the MAC layer management unit may determine whether to forward an error-free MSDU to the upper layer based on an RROE field of the MSDU where the error occurred.

In this instance, when an RROE field of an MSDU where the error occurred is ‘0’, it may be assumed that retransmission is not required when the error occurs. Also, when the RROE field of the MSDU where the error occurred is ‘1’, it may be assumed that retransmission is required when the error occurs.

When the RROE field of the MSDU where the error occurred is ‘1’, the MAC layer management unit 220 may forward, to the upper layer, an MSDU with a sequence number less than a sequence number of the MSDU where the error occurred. Also, the MAC layer management unit 220 may store, in a receiving buffer, an MSDU with a sequence number greater than the sequence number of the MSDU where the error occurred.

When the RROE field of the MSDU where the error occurred is ‘0’, the MAC layer management unit 220 may forward an error-free MSDU to the upper layer based on a sequence number of the error-free MSDU.

Also, the MAC layer management unit 220 may record the MSDU where the error occurred in a register, and generate an ACK frame including a value of the register. Also, the MAC layer management unit 220 may forward the ACK frame to the PHY layer management unit 230.

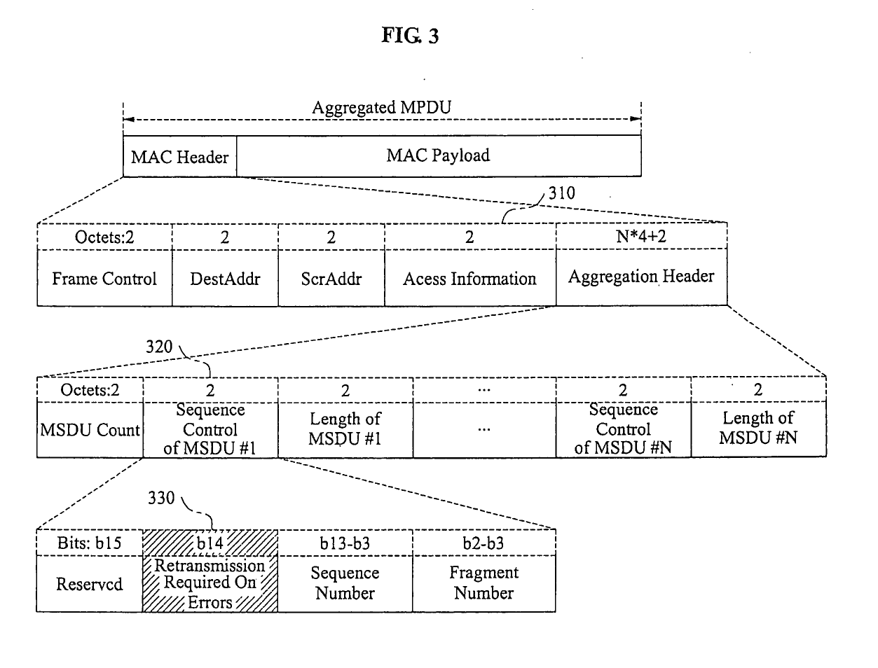

FIG. 3 is a diagram illustrating an example of a frame format of an aggregated MPDU according to an embodiment of the present invention.

In FIG. 3, an ‘access information’ field 310 of a MAC header may include information about an ACK policy of an MSDU. For example, the ACK policy may generally include an Immediate-Acknowledgement(Imm-ACK), a Block ACK, a Block ACK request, a NO-ACK, and the like.

As shown in FIG. 3, the frame format of the aggregated MPDU may be similar to a frame format of an aggregated MPDU for a super high-speed wireless transmission in a conventional art. However, the frame format of the aggregated MPDU may be different from the frame format of the aggregated MPDU in a conventional art in that a ‘Retransmission Required On Errors (RROE)’ field 330 is added to a ‘sequence control’ field 320 for each MSDU in an aggregation header.

The RROE field 330 may have information about whether retransmission is required when an error occurs in a corresponding MSDU. That is, when an RROE field 330 is ‘0’, retransmission may not be required when the error occurs, and when the RROE field 330 is ‘1’, retransmission may be required when the error occurs.

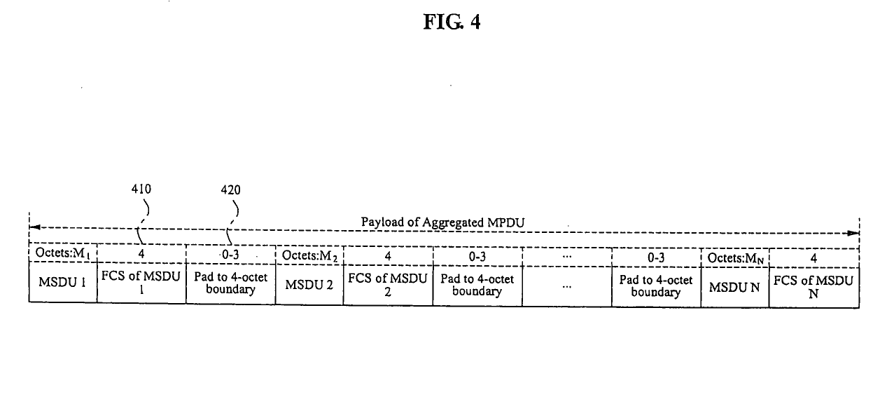

FIG. 4 is a diagram illustrating an example of a format of a MAC payload field of FIG. 3.

Referring to FIG. 4, the MAC payload field may include a ‘Frame Check Sequence (FCS)’ field and a ‘pad to 4-octet boundary’ field. Whether an error occurs in each MSDU may be confirmed in the FCS field, and the ‘pad to 4-octet boundary’ field may have information about a length of each of the MSDUs.

As shown in FIG. 4, a ‘FCS of MSDU 1’ field 410 may include information to confirm whether the error occurs in an MSDU 1, a ‘pad to 4-octet boundary’ field 420 may include length information of the MSDU 1.

Accordingly, a receiving apparatus may confirm whether the error occurs for each of the MSDUs, and request that a transmission apparatus retransmits only MSDUs where an error occurred.

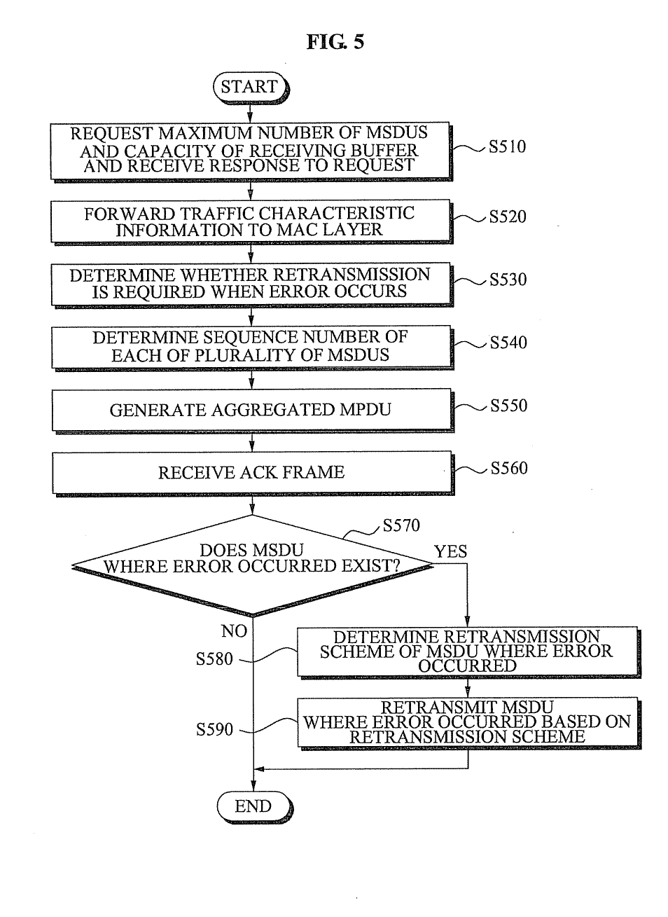

FIG. 5 is a flowchart illustrating a method of packet aggregation according to an embodiment of the present invention.

Operations of a transmission apparatus for packet aggregation are illustrated in FIG. 5.

Referring to FIG. 5, the method of packet aggregation may include determining whether to retransmit in operation S530, determining a sequence number of each of a plurality of MSDUs in operation S540, and generating an aggregated MPDU in operation S550.

Specifically, in operation S510, the transmission apparatus may request a receiving apparatus for a maximum number of processible MSDUs of the receiving apparatus and a capacity of a receiving buffer, and receive a response to the request.

In operation S520, the transmission apparatus may forward traffic characteristic information of each of the plurality of MSDUs to a MAC layer from an upper layer.

In operation S530, the transmission apparatus may determine whether retransmission is required for each of the plurality of MSDUs when an error occurs, based on the traffic characteristic information of each of the plurality of MSDUs.

In this instance, the traffic characteristic information of each of the plurality of MSDUs may include information about whether retransmission is required for each of the plurality of MSDUs, information about whether real-time transmission of each of the plurality of MSDUs is required, and the like. In this instance, the information about whether retransmission is required, the information about whether real-time transmission is required, and the like may be set differently depending on a high priority video packet, an audio packet, a video packet where an UEP is applied, and the like.

Also, in operation S530, the transmission apparatus may set an RROE field for each of the plurality of MSDUs depending on whether retransmission is required. That is, an RROE field of an MSDU requiring retransmission upon errors may be set as ‘1’, and an RROE field of an MSDU that does not require retransmission upon errors may be set as ‘0’.

In operation S540, the transmission apparatus may determine a sequence number of each of the plurality of MSDUs depending on whether retransmission is required when the error occurs.

In this instance, a sequence number of the MSDU requiring retransmission upon errors from among the plurality of MSDUs may be determined to be greater than a sequence number of the MSDU that does not require retransmission upon errors.

That is, the transmission apparatus may determine the sequence number of each of the plurality of MSDUs to enable the MSDU requiring retransmission upon errors to be located in a rear portion of the aggregated MPDU.

In operation S550, the transmission apparatus may generate the aggregated MPDU based on the sequence number.

In operation S560, the transmission apparatus may transmit the aggregated MPDU to a destination through a PHY layer, and receive an ACK frame from the receiving apparatus according to a predetermined ACK policy.

In operation S570, the transmission apparatus may confirm, using the ACK frame, whether an MSDU that requires retransmission upon error exist where an error occurred, and which MSDUs, that require retransmission upon errors, an error occurs in from among the plurality of MSDUs, and determine whether an MSDU where the error occurred exist from among the MSDUs requiring retransmission upon errors.

When the MSDU where the error occurred exists from among the MSDUs requiring retransmission upon errors, the transmission apparatus may determine a retransmission scheme of the MSDU where the error occurred from among the MSDUs requiring retransmission upon errors, based on a delay request of the MSDU where the error occurred.

In this instance, the delay request of the MSDU where the error occurred may be high or low depending on whether real-time transmission of a corresponding MSDU is required. Accordingly, the retransmission scheme of the MSDU where the error occurred may be any one of a retransmission scheme of including the MSDU where the error occurred in a subsequent aggregated MPDU for retransmission, a retransmission scheme of configuring a plurality of MSDUs where errors occurred as the aggregated MPDU for retransmission, and a retransmission scheme of configuring a single MSDU where the error occurred as an MPDU for retransmission.

Also, in operation S580, the transmission apparatus may determine whether retransmission is required when the error re-occurs in the MSDU where the error occurred, based on a predetermined maximum number of retransmissions and the delay request of the MSDU where the error occurred from among the MSDUs requiring retransmission upon errors.

In operation S590, the transmission apparatus may retransmit an MSDU to be retransmitted based on the determined retransmission scheme.

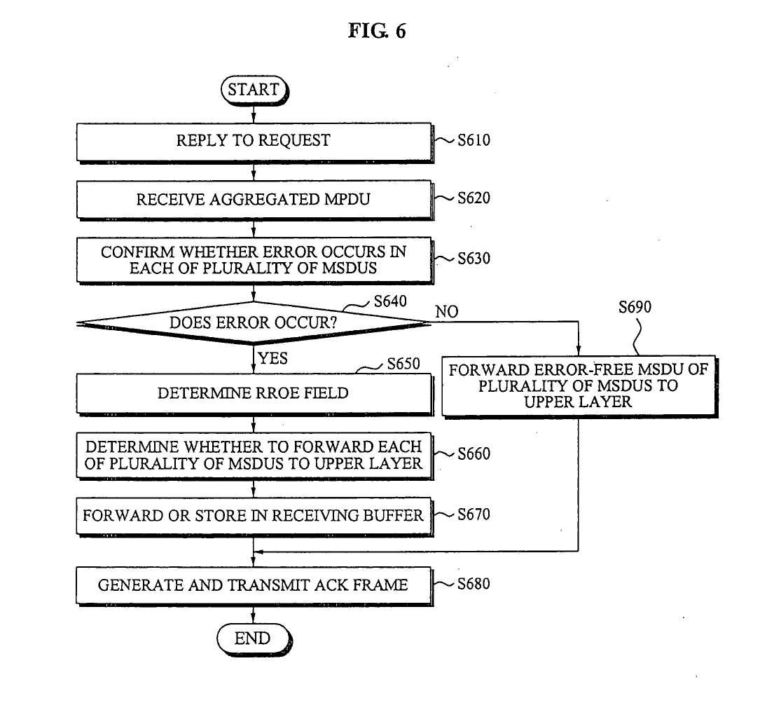

FIG. 6 is a flowchart illustrating a method of packet aggregation according to another embodiment of the present invention.

Operations of a receiving apparatus for packet aggregation are illustrated in FIG. 6.

Referring to FIG. 6, the method of packet aggregation may include receiving an aggregated MPDU in operation S620, confirming in operation S630, determining whether an error occurs in operation S640, determining an RROE field in operation S650, and determining whether to forward in operation S660.

Specifically, in operation S610, the receiving apparatus may reply, to a transmission apparatus, a maximum number of processible MSDUs of the receiving apparatus and a capacity of a receiving buffer, in response to a request from the transmission apparatus.

In operation S620, the receiving apparatus may receive the aggregated MPDU including a plurality of MSDUs.

In operation S630, the receiving apparatus may confirm whether an error occurs in each of the plurality of MSDUs based on a sequence number of each of the plurality of MSDUs.

In operation S640, the receiving apparatus may determine whether the error occurs in at least one MSDU of the plurality of MSDUs. When the error occurs, the receiving apparatus may determine an RROE field of the MSDU where the error occurred in operation S650. Here, the RROE field may indicate whether retransmission is required in the MSDU where the error occurs.

In operation S660, the receiving apparatus may determine whether to forward each of the plurality of MSDUs to an upper layer based on the RROE field of each of the plurality of MSDUs.

That is, when the RROE field of the MSDU where the error occurred indicates that retransmission is required when the error occurs, the receiving apparatus may forward, to the upper layer, an MSDU with a sequence number less than a sequence number of the MSDU where the error occurred, or the receiving apparatus may store, in the receiving buffer, an MSDU with a sequence number greater than the sequence number of the MSDU where the error occurred in operation S670.

When the RROE field of the MSDU where the error occurred indicates that retransmission is not required when the error occurs, the receiving apparatus may forward an error-free MSDU of the plurality of MSDUs to the upper layer based on the sequence number of the error-free MSDU.

In operation S680, the receiving apparatus may record the MSDU where the error occurred in a register, and generate an ACK frame including a value of the register. In this instance, the ACK frame including the value of the register may be forwarded to the transmission apparatus through a PHY layer.

When it is determined that the error is not generated in all the plurality of MSDUs in operation S640, the receiving apparatus may forward each of the plurality of MSDUs to the upper layer based on a sequence number of each of the plurality of MSDUs in operation S690.

The method of packet aggregation is described below in greater detail as an example.

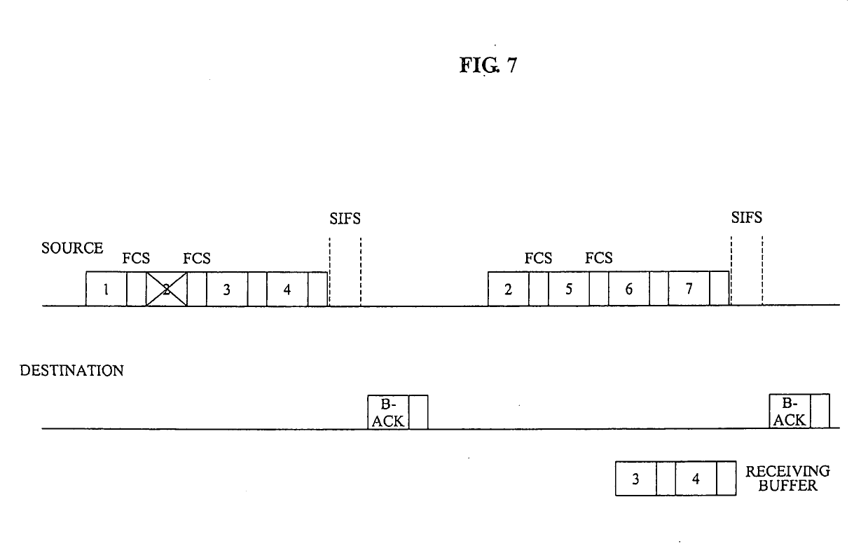

FIG. 7 is a diagram illustrating an example of a packet aggregation without an RROE field in a conventional art.

FIG. 7 illustrates an example when all MSDUs perform retransmission regardless of traffic characteristic of each of the MSDUs. In FIG. 7, an error occurs in an MSDU 2 when an aggregated MPDU including four MSDUs is transmitted, and the MSDU where the error occurred is retransmitted by including the MSDU where the error occurred in a subsequent aggregated MPDU. In a destination, an MSDU 1 may be forwarded to an upper layer. However, although an MSDU 3 and an MSDU 4 may be successfully received, the MSDU 3 and the MSDU 4 may not be forwarded to the upper layer and be stored in a buffer.

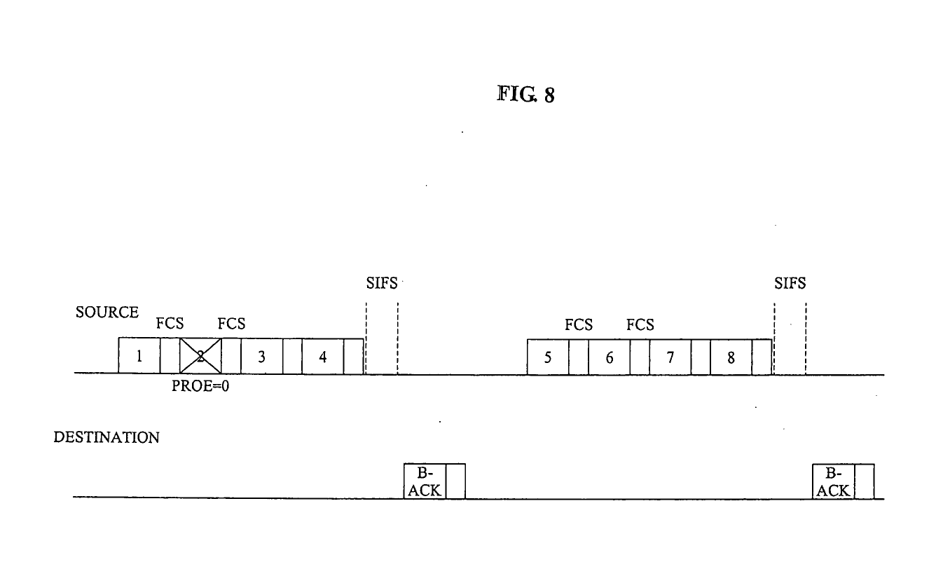

FIG. 8 is a diagram illustrating an example when an RROE field is set as ‘0’ according to an embodiment of the present invention.

Referring to FIG. 8, when an error occurs in an MSDU 2 where an RROE field is ‘0’, a transmission apparatus may not retransmit the MSDU 2, and a receiving apparatus may forward an MSDU 1, an MSDU 3, and an MSDU 4 to an upper layer without waiting for the retransmission of the MSDU 2.

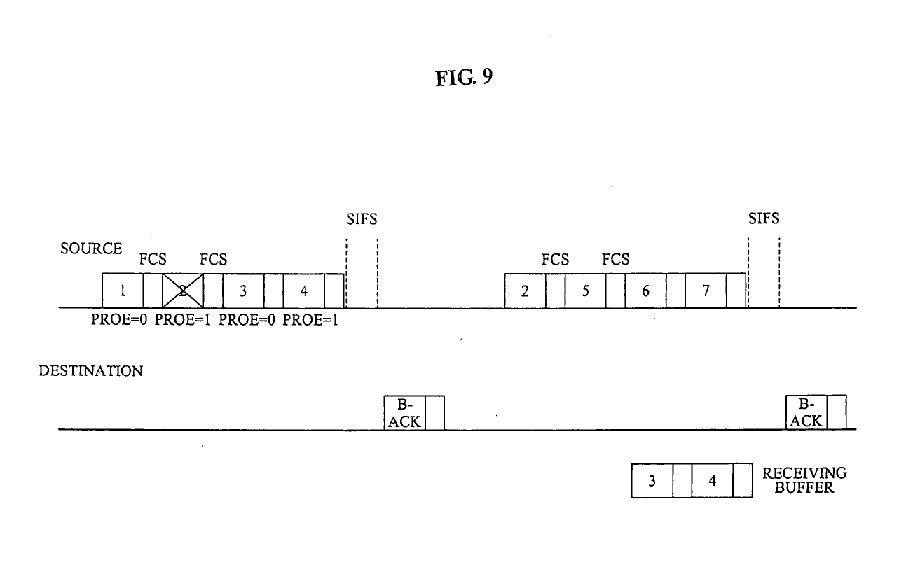

FIG. 9 is a diagram illustrating an example when an RROE field is set as 1 according to an embodiment of the present invention.

Referring to FIG. 9, when MSDUs where an RROE field is set as ‘1’ are not located in a rear portion of an aggregated MPDU and variously placed, a receiving error occurs and retransmission is required. In this instance, an example of a buffer state of a receiving end is illustrated in FIG. 9. In this case, it may be ascertained that an MSDU 3 and an MSDU 4 are stored in a receiving buffer to wait for the retransmission of the MSDU 2.

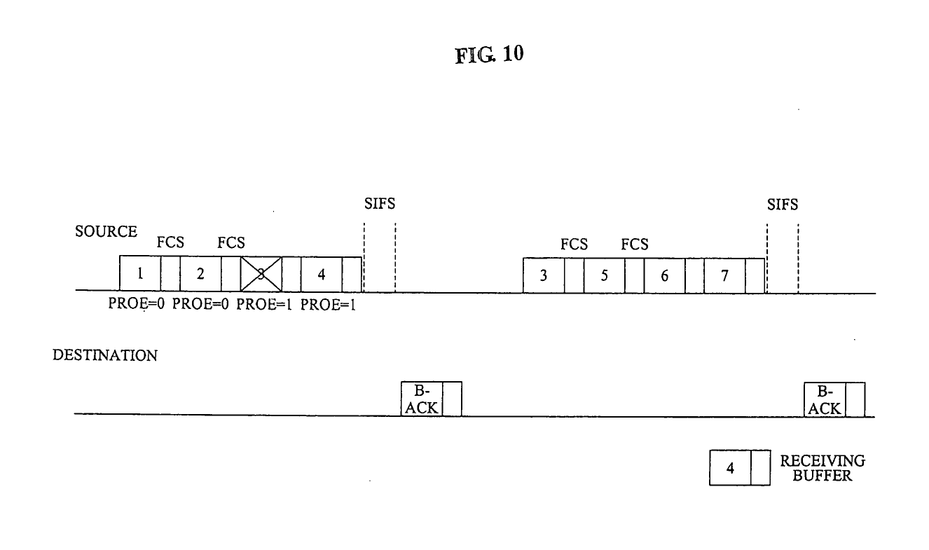

FIG. 10 is a diagram illustrating another example when an RROE field is set as 1 according to an embodiment of the present invention.

Referring to FIG. 10, when MSDUs where an RROE field is set as ‘1’ are located in a rear portion of an aggregated MPDU, an example of a buffer state of a receiving end is illustrated in FIG. 10. In this case, it may be ascertained that an MSDU 1 and an MSDU 2 may be directly forwarded to an upper layer, and only MSDU 4 may be stored in a receiving buffer. Accordingly, the receiving buffer may be efficiently used.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for packet aggregation, the apparatus comprising:
an upper layer management unit to generate a plurality of Media Access Control (MAC) Service Data Units (MSDUs) and traffic characteristic information of each of the plurality of MSDUs;
a MAC layer management unit to determine a sequence number of each of the plurality of MSDUs based on the traffic characteristic information of each of the plurality of MSDUs, and to generate an aggregated MAC Protocol Data Unit (MPDU) based on the sequence number of each of the plurality of MSDUs; and
a physical (PHY) layer management unit to transmit the aggregated MPDU to a destination.

2. The apparatus of claim 1, wherein the aggregated MPDU includes a Retransmission Required On Errors (RROE) field indicating whether retransmission is required for each of the plurality of MSDUs when an error occurs.

3. The apparatus of claim 2, wherein the MAC layer management unit determines a sequence number of an MSDU, that requires retransmission upon errors, to be greater than a sequence number of an MSDU that does not require retransmission upon errors from among the plurality of MSDUs.

4. The apparatus of claim 1, wherein, when an acknowledgement (ACK) frame corresponding to the aggregated MPDU is received, the MAC layer management unit confirms, using the ACK frame, which MSDUs an error occurs in from among the plurality of MSDUs, the MSDUs requiring retransmission upon errors, and the MAC layer management unit also determines a retransmission scheme of an MSDU where an error occurred from among the MSDUs requiring retransmission upon errors based on a delay request of the MSDU where the error occurred.

5. The apparatus of claim 4, wherein the retransmission scheme is any one of a retransmission scheme of including the MSDU where the error occurred in a subsequent aggregated MPDU for retransmission, a retransmission scheme of configuring a plurality of MSDUs where errors occurred as the aggregated MPDU for retransmission, and a retransmission scheme of configuring a single MSDU where the error occurred as an MPDU for retransmission.

6. The apparatus of claim 4, wherein the MAC layer management unit determines whether retransmission is required when the error re-occurs in the MSDU where the error occurred, based on a predetermined maximum number of retransmissions and the delay request of the MSDU where the error occurred from among the MSDUs requiring retransmission upon errors.

7. An apparatus for packet aggregation, the apparatus comprising:
a PHY layer management unit to receive an aggregated MPDU including a plurality of MSDUs and an RROE field indicating whether retransmission is required for each of the plurality of MSDUs when an error occurs; and
a MAC layer management unit to forward the plurality of MSDUs to an upper layer based on a sequence number of each of the plurality of MSDUs, and when the error occurs in at least one MSDU of the plurality of MSDUs, the MAC layer management unit determines whether to forward an error-free MSDU to the upper layer based on an RROE field of the MSDU where the error occurred.

8. The apparatus of claim 7, wherein, in the aggregated MPDU, a sequence number of an MSDU, that requires retransmission upon errors, is determined to be greater than a sequence number of an MSDU that does not require retransmission upon errors.

9. The apparatus of claim 7, wherein, when the RROE field of the MSDU where the error occurred indicates that retransmission is required upon errors, the MAC layer management unit forwards, to the upper layer, an MSDU with a sequence number less than a sequence number of the MSDU where the error occurred, and stores, in a receiving buffer, an MSDU with a sequence number greater than the sequence number of the MSDU where the error occurred.

10. The apparatus of claim 9, wherein, when the RROE field of the MSDU where the error occurred indicates that retransmission is not required upon errors, the MAC layer management unit forwards the error-free MSDU of the plurality of MSDUs to the upper layer based on the sequence number of the MSDU where the error occurred.

11. The apparatus of claim 9, wherein the MAC layer management unit records the MSDU where the error occurred in a register, generates an ACK frame including a value of the register, and forwards the ACK frame to the PHY layer management unit.
